(19) United States
(12) Patent Application Publication
(10) Pub. No.: US 2017/0045751 A1
(43) Pub. Date: Feb. 16, 2017

(54) Interactive Device for the Selective Control of Electromagnetic Radiation

(71) Applicant: Politecnico Di Milano, Milano (IT)

(72) Inventor: Nicola Levati, Milano (IT)

(21) Appl. No.: 15/305,398

(22) PCT Filed: Apr. 21, 2015
(86) PCT No.: PCT/IB2015/052901

§ 371 Date: Oct. 20, 2016

(30) Foreign Application Priority Data
Apr. 22, 2014 (IT) RM2014A000206

(51) Int. Cl. G02B 27/28; G02B 5/20; E06B 9/24; G02B 5/30

(52) U.S. Cl. CPC G02B 27/281; G02B 5/3058; G02B 5/208; E06B 9/24; E06B 2009/2417

(57) ABSTRACT

The present invention relates to the technical field of systems for the polarisation of electromagnetic radiation, particularly light radiation, and more particularly solar radiation. The present invention also relates to the application of such systems to the dynamic screening of essentially transparent surfaces, particularly in the building construction, automotive, architecture and interior design sectors and other sectors that require such screening.

### CROSS REFERENCE TO RELATED APPLICATIONS

This application is the U.S. national phase application of PCT application number PCT/IB15/052901, which was filed on Apr. 21, 2015, and claims priority to Italian patent application number RM2014A000206, which was filed on Apr. 22, 2014. The contents of each are incorporated by reference herein, in their entirety and for all purposes.

### FIELD OF THE INVENTION

The present invention relates to the technical field of systems for the polarisation of electromagnetic radiation, particularly light radiation, and more particularly solar radiation.

The present invention also relates to the application of such systems to the dynamic screening of essentially transparent surfaces, particularly in the building construction, automotive, architecture and interior design sectors and other sectors that require such screening.

### BACKGROUND OF THE INVENTION

Modern building construction involves wide-ranging use of large glazed surfaces. These surfaces have an aesthetic function, deriving from the architectonic design, but are also intended to allow bright illumination of the interior environments.

However, the use of these surfaces is not free from problems and disadvantages. In winter, glazed surfaces are less insulating than the opaque brickwork structures of the building and disperse more heat. This demands a greater expenditure of energy for adequate heating of the environments. In summer, on the other hand, the glazed surfaces, subjected to intense radiation, produce what is known as the greenhouse effect, with strong heating of the internal environment. In addition, intense solar radiation requires the adoption of adequate internal and/or external screening systems on the building.

Some examples of modern screening systems are photochromic and thermochromic variable-transparency windows, and suspended-particle and electrochromic variable-transparency windows.

These systems offer a certain degree of efficiency and versatility. However, there is also a need to be able to select the type of electromagnetic radiation, particularly light radiation, and more particularly solar radiation. For example, it may be desirable to block the ultraviolet (UV) portion of the radiation, which is known to be harmful; or the near-infrared (NIR) portion, which is responsible for the heating of the internal environment; or the light radiation in order to regulate its intensity in situations of strong sunshine for other needs.

U.S. Pat. No. 5,164,856 describes a transmittance-adjustable window incorporating a device that uses two polarisers. This system does not allow the selection of a radiation region.

U.S. Pat. No. 8,508,681 describes, without giving any particular practical application, a variable optical transmittance device comprising “patterned” polarisers capable of providing continuous or nearly continuous variations in light transmittance. This device is not capable of selecting specific regions of electromagnetic radiation.

Therefore, there remains a felt need to have a device capable of screening electromagnetic radiation, particularly light radiation, and more particularly solar radiation, in a selective and dynamic manner.

There is also a felt need for a screening method for a surface transparent to electromagnetic radiation, particularly light radiation, and more particularly solar radiation, that makes it possible to select the type of electromagnetic radiation and allows regulation of the transmission of the said radiation. This need is felt particularly for the light radiation to which the transparent surface is exposed, and more particularly for ultraviolet and/or visible spectrum and/or near-infrared radiation.

This need is felt particularly for glazed surfaces used in building construction.

### SUMMARY OF THE INVENTION

It has now been found that the above-mentioned problems of the prior art, particularly the ability to select the electromagnetic radiation, either by blockage/absorption or by reflection, in the design phase of the device, and to regulate at will the transmittance of the electromagnetic radiation, particularly light radiation and/or near-infrared radiation (also understood as thermal radiation), are solved with the present invention.

Surprisingly, it has been found that by determining a constant pitch between the filaments of two nano-structured polarisers at a certain wavelength and coupling the said polarisers in such a manner that they can perform a reciprocal linear translatory motion, the problems outlined above are solved.

The present invention concerns a transparent multilayer device comprising two polarisers of the nano-structured, selective, passive and non-uniform “wire grid” type, the said polarisers being arranged in succession along the path of the direction of propagation of the electromagnetic radiation and each of the said polarisers being capable of performing a linear translatory motion with respect to one another, where the pitch between the filaments is constant and less than 390 nm, the said filaments occupy an essentially constant space between 2.5% and 50% of the pitch period, the said filaments are organised in parallel bands of regular shape, and the said bands are of the same dimensions but have different orientations of the polarisation axis, where the polarisation axis of each band is rotated clockwise or anti-clockwise, with respect to that of the adjacent bands, through constant angles selected in the range between tenths of a degree and 45 degrees.

The present invention provides the advantage of selectively screening incident radiation, for example solar radiation.

The device according to the invention allows polarisation of the visible and thermal spectrum or transmittance of the visible spectrum and polarisation of the thermal spectrum.

The device according to the invention is capable of providing a gradual and homogeneous passage between the position of maximum transmittance and the position of minimum transmittance of the polarised component, thus improving its optical properties.

The implementation of the device according to the invention is simpler with respect to other known devices, since the components devoted to the dynamic regulation of electromagnetic radiation are based on just two bi-dimensional, nano-structured, non-uniform, wire-grid polarising filters rather than a greater number of components as in certain known devices.

Advantageously, the device according to the present invention allows selective dynamic screening with regard to the thermal component of solar radiation.

The device according to the present invention provides a substantial improvement in visual comfort, since it is possible to obtain an almost constant transmittance in the visible range [>63%] that exceeds the 50% “theoretical maximum” obtainable with ideal polarisers.

The present invention will be illustrated in detail below in its general form and in certain manners of implementation, together with additional advantages.

### BRIEF DESCRIPTION OF THE DRAWINGS

FIG. 1 shows the selective transmittance characteristics, by way of example, for implementation with respect to VIS+NIR (e.g. double filter, constant filament pitch of approximately 100 [nm], filament height of approximately 100 [nm]) and NIR (e.g. double filter, constant filament pitch of approximately 230 [nm], filament height of approximately 120 [nm]). The values are placed in relation to the percentage energy distribution of the solar spectrum.

FIG. 2 shows, on a [%] scale, the spectral transmittance values of the same devices, exemplifying the implementation and performance possibilities of this invention.

FIG. 3 shows an example of implementation of the present invention, noting the orientation and constant pitch of the filaments in the parallel bands of equal dimensions.

FIG. 4 shows another example of implementation of the present invention, noting the orientation of the parallel bands, the filaments and the relative angle of rotation, and a possible dividing strip.

FIG. 5 shows another example of implementation of the present invention, noting in three-dimensional representation the orientation and constant dimensions of the parallel bands of the filaments and the relative angle of rotation, and a possible dividing strip. The type, stratigraphy, form and deposition side of the filament, shown in 3D cross-section as a simple, non-limitative example of the form of implementation, vary according to the technological/production process used and the desired degree of efficiency/selectivity.

FIG. 6 shows spectral curves representing the minimum and maximum reflectance and absorption values obtained with the device according to the present invention.

### DETAILED DESCRIPTION OF THE INVENTION

The device according to the present invention uses two non-uniform anisotropic polarisers of the “wire grid” type. Through the calculation and design of a specific nanometric-scale pattern, the present invention solves the problem of selective and dynamic screening of solar radiation.

Polarisers of the “wire grid” type used in the present invention are known to experts in the field. Reference can be made to the general technical literature. Examples are described in JP-2012155163, US20080316599 and US20050128587.

The device according to the present invention provides for the two polarisers to be placed in succession along the path of the direction of propagation of the electromagnetic radiation, and these, when subjected to linear translatory motion, in a direction opposite to the main direction of the design, allow selective transmittance and reflection of the range of solar radiation for which they were designed, eliminating the problem of overheating of the filtering surfaces. The purpose of the selectivity sought in the design of the filter is to achieve high solar gains in the winter and reduced solar contributions in the summer, with a consequent energy saving in terms of lighting, heating and cooling.

In one form of implementation, the device is equipped with a control system that periodically processes a multiplicity of data deriving from a series of transducers suitably arranged in the environment, which monitor: the position/presence of the sun, the intensity of the radiation in the visible component (380-780 nm) and the near-infrared component (780-2500 nm), the internal and external temperature, the level of humidity present in the confined environment, the presence of humans in the premises, and the choices of manual and automatic settings desired by the user. It is also possible to transmit the report on the recorded data via a network connection in order to develop and improve the predictive abilities of the software installed in the microcontroller.

A system of actuators, preferably precision models, allows the device to move the two polarising filters in a translatory motion through the use of suitable means, for example nano-servomotors.

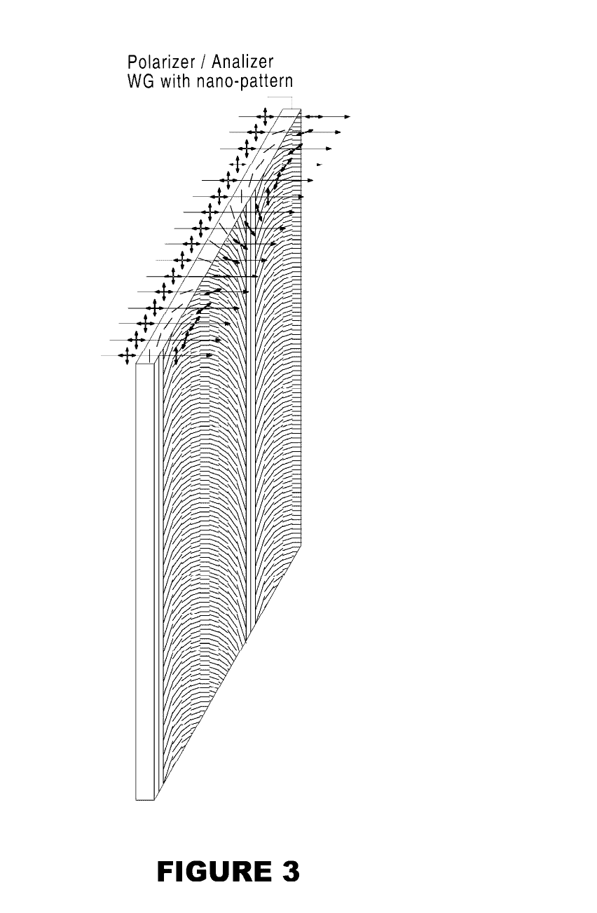

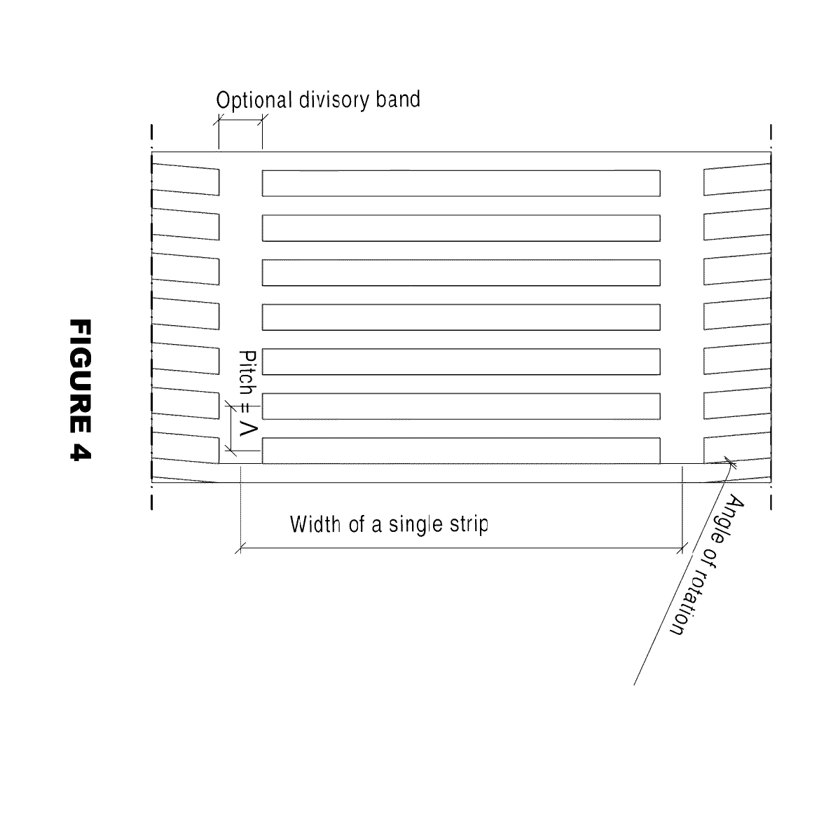

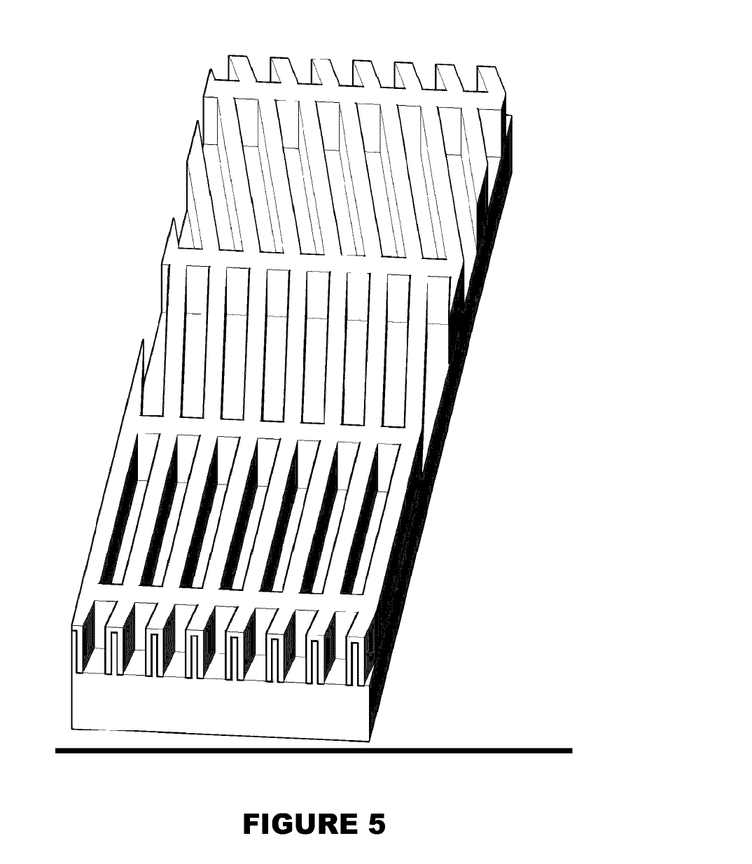

Wires structured according to multiple orientations on a transparent substrate, optionally covered by a further transparent protective layer, constitute the non-uniform polarising reticle of the two polarising filters. Each filter contains a multitude of polarisation axes according to the width and number of bands in the pattern that is being created. FIGS. 3-6 show an example of implementation of the present invention.

In a first implementation of the invention, the nano-oriented filaments of the polariser are created with pitches in the range 160<pitch<390 [nm]. In this case, an “NIR” selective device is obtained.

Following translatory movement, which may be horizontal, vertical, curvilinear or sinusoidal, with sections of different or oblique orientations, of one of the two patterns, the “near-infrared” portion of the thermal spectrum is polarised and therefore selectively regulated while maintaining high levels of transmittance in the visible radiation portion [Tvis>63%]. This is due to the low polarising capacity of these specific 380-780 wavelengths, which are shorter than those of the near-infrared range.

These selectivity characteristics solve the problem of the application of dynamic technologies to transparent architectonic surfaces, including those of small and medium-sized dimensions.

In a second implementation of the invention, the nano-oriented filaments are created with pitches of less than 160 [nm], and a “VIS+NIR” selective device is obtained.

Each filter contains a multitude of polarisation axes according to the number and width of bands in the pattern. Following translatory movement of one of the two patterns, the VIS and NIR components are reduced in a virtually linear manner. This solution is therefore the most appropriate choice where there are large glazed surfaces that provide a high level of solar gain in the warmest season.

In one implementation of the invention, additional layers can be added, for example by adhesion, with respect to the two polarising filters, thus creating movable or partially movable transparent devices, double-glazing units with integrated screening or navigable spaces. According to the type of application, the number of transparent layers that constitute the device will therefore vary, along with their rigidity, distance, type and dimensions.

The two polarising filters are nano-structured according to the solar component that has been chosen to control (UV and/or VIS and/or NIR), and have numerous polarisation axes so as to provide the capacity for passive but dynamic regulation of the electromagnetic radiation following linear translatory movement (horizontal, vertical, curvilinear or sinusoidal, with sections of different or oblique orientations) of one of the two or both. This linear translatory movement results from a double and/or single translatory movement of the single polariser and/or both polarisers. In one form of implementation of the invention, the translatory movement resulting from a double translatory movement of one and/or both of the filters allows the control of inter-reflection phenomena, thus favouring stabilisation of the transmittance parameters.

The device in the implementation in which the pattern is designed to regulate the level of transmittance and reflection of the NIR thermal component only (constant inter-filament pitch of between 160 and 390 [nm]) allows virtually unaltered or partially polarised transmittance of the visible component and absorbs the UV component by means of the transparent substrate and/or by means of the protective layer.

The device in the implementation in which the pattern is designed to selectively regulate the transmittance of the UV-VIS+NIR components, or VIS+NIR only with the UV absorbed, has a constant inter-filament pitch of <160 [nm].

In certain conditions the incident radiation on one or both of the main faces of the device is partially polarised, for example in the visible range due to the vibration of gas atoms present in the atmosphere or due to the presence of strong reflected components from architectonic, urban or natural elements situated in the vicinity of the device.

In one form of implementation of the present invention, and in order to improve the optics of the device, the electromagnetic radiation passes, along its direction of propagation, through a depolariser before striking the polarisers of the said device.

In this form of implementation, the partially polarised incident electromagnetic radiation passes through the depolariser, where its main polarisation axis is rotated through various angles, according to the specific characteristics of the filter, and exits from it depolarised. The linear depolariser and the patterned depolariser are filters known to experts in the field (for example, microretarder achromatic depolariser array/pattern, liquid crystal polymer achromatic depolariser, quartz-wedge achromatic depolariser, etc.) and are effective instruments for solving the main optical problems posed by the environment in which the device is used.

The filter that receives the solar radiation first, because it is more external, comprises 2 or 3 components adhered to one another. A rigid or flexible transparent substrate is always present, with a refractive index of between 1.3 and 2.7 and calculated so as to exclude high orders of diffraction in the visible range. This calculation method is already known in the prior art; see, for example, US20050128587. The substrate is chosen from known inorganic and/or organic materials with a high capacity for transmittance of the VIS and NIR components, and optionally with a high capacity for absorption of the UV component.

Its surface may be smooth or structured according to nano-oriented relief geometries and prepared for future fixation of the metallic polarising pattern.

Transparent materials with a refractive index of between 1.3 and 2.7 are the most suitable for creating the substrate of the selective wire grid polariser. Those most commonly used for creating the substrates of these polarisers are, for example, of inorganic origin: glasses or ceramics, or of inorganic origin: polymethylmethacrylate, polystyrene resin, polycarbonate, polyvinyl chloride resin, polyester resin, polyethylene resin, ketonic resins, polyphenol resins, polysulfone resin, polypropylene, polybutylene terephthalate, acrylic resins, epoxy resin, urethane-based resins, cellulose triacetate, etc.

The substrates and the upper protective layers of organic origin are preferably chosen from among those that are capable of hardening if subjected to thermal radiation (“thermosetting”) or from among the resins that harden under ultraviolet radiation, as used in certain nano-fabrication processes.

The material to be used for the construction of the polarising reticle must have a high reflective index. Consequently, aluminium or silver are generally used, but precious metals such as gold, platinum, copper or other highly reflective alloys may also be used.

In the case of applications in which the normally reflected radiation component must be absorbed, multilayer nano-wires are created that consist of dielectric material alternating with layers of non-dielectric material. A description of the overlay procedure and the choice of components to be used can be found in US20080316599.

For the superficial protection material, transparent materials of polymeric origin are generally used (polyethylene terephthalate, cellulose triacetate, etc.) with adhesives or oxides of silicon, titanium, aluminium, zinc, zirconium, etc.

The preferred nano-fabrication techniques for the creation of large wire grid surfaces are the nano-imprint lithography (NIL) techniques, particularly those using the Roll-to-Roll process, which allow the creation of large surfaces replicable through extensions of up to hundreds of metres depending on the thickness of the filter produced.

According to the technique used for the deposition of the metallic filaments and the type of material chosen for the substrate, there may be a layer of dielectric material between the transparent substrate and the polarising pattern, capable of improving the adhesion between the metallic filaments and the substrate. The dielectric material is generally chosen from among the oxides of metals such as silicon, nitrides, halides, and similar materials.

There is always a polarising pattern present, created with nano-constructed reflective metallic wires on the transparent substrate.

The pattern is characterised by a single metallic reticle constructed in parallel bands of regular form and dimensions, where each band is created from nano-wires made from reflective material with the same geometrical characteristics and arranged at regular (i.e.

constant) pitches (<390 [nm]) so that they can selectively interact with the most suitable range of solar radiation for the intended use.

In width, the metallic wires occupy an essentially constant space between 2.5 and 50% of the pitch period; the thickness of the deposited metallic layer and the height of the filaments vary greatly according to the chosen pitch and the desired efficiency in terms of suppression of electromagnetic radiation. To increase the polarising efficiency, it is also desirable that the deposition of the metallic layer should not concern both the main sides of the filament created on the transparent substrate.

For the purposes of the present invention, the term “essentially constant” means that variations may be made with regard to the range stated above, provided that the functions of the device according to the present invention are not altered or compromised.

Therefore the height of the nano-wires, for the wavelengths considered, always remains between (10 [nm]<h<1 [μm]), and within this range a value between 60 and 180 [nm] is preferred, without ruling out other possible implementations with h<1 [μm].

The bands are of equal dimensions but have different orientations with respect to the polarisation axis.

The width of each band depends on the type of application of the device and varies from 5 micrometres to 9.9 metres.

The polarisation axis of each band is rotated, with respect to that of the adjacent bands, through constant angles selected in the range between tenths of a degree and 45 degrees.

The smaller this angle, the greater will be the intermediate transmittance levels between the maximum and minimum transmittance levels of the polarised component.

The different polarisation angles of the bands rotate in one direction, clockwise or anti-clockwise, to form a pattern that is repeated over the entire surface of the almost bi-dimensional filter. See FIGS. 3-5.

The optional third transparent element is a layer of protection for the polarising pattern that is created according to the intended use. This layer may have the function of filtering ultraviolet (UV) radiation and/or the function of increasing the level of transmittance of the electromagnetic radiation not polarised by the metallic pattern. It has high transparency in the visible and near-infrared regions, and is chosen and then verified numerically according to its refractive index, which must always be greater than 1.3.

The filter that receives the solar radiation secondly, filtered and polarised by the first filter, is characterised and behaves like the first polariser.

For devices in which it is important to have maximum visual dimming and/or maximum suppression capacity over the entire range of the solar spectrum (UV-VIS-NIR), the second pattern is created like the first but with multilayer nano-wires capable of selectively absorbing the polarised component orthogonally to the transmitted component.

Both of the polarising filters are created using nano-fabrication techniques, of which the best-known for the fabrication of large surfaces are the nano-imprint lithography (NIL) techniques using Roll-to-Roll processes, although other known techniques may be used as an alternative to nanolithography.

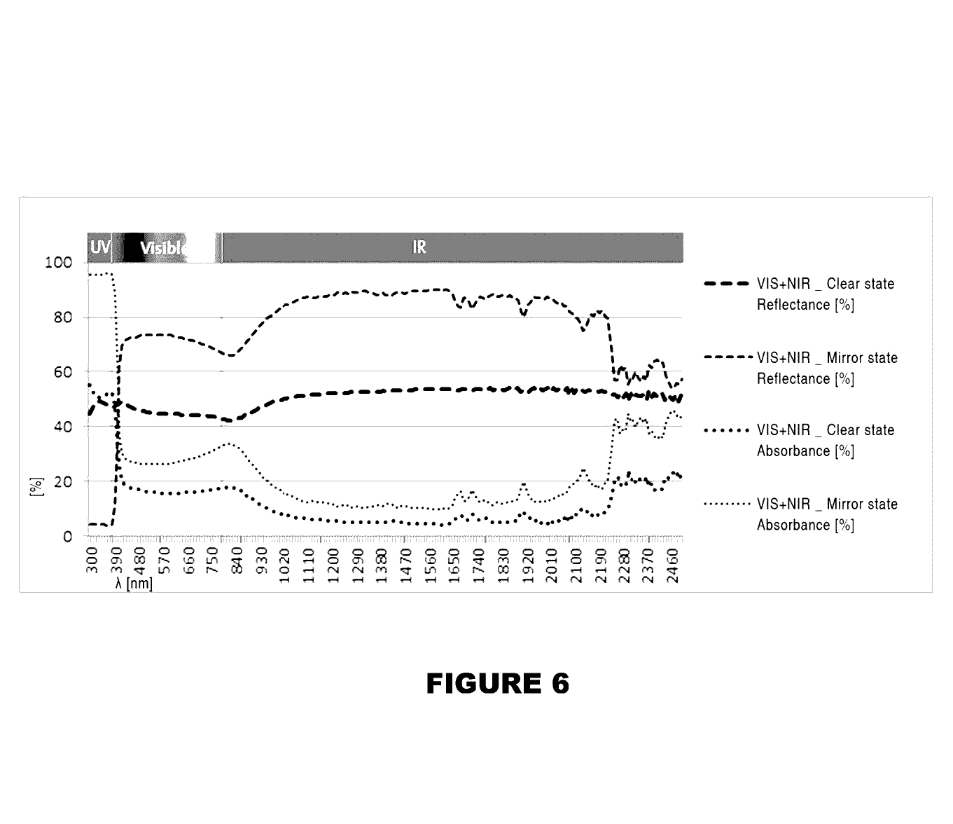

Maximum transmittance of the polarised component is obtained when the various polarisation axes of the first and the second filter are parallel to each other and aligned along the direction of propagation of the incident electromagnetic wave. The component of the electromagnetic radiation orthogonal to the polarisation axis, which allows the transmittance, is polarised and reflected. Minimum transmittance of the polarised component is obtained when the various polarisation axes of the first and the second filter are orthogonal to each other and aligned along the direction of propagation of the incident electromagnetic wave. In this case, reflection is at its maximum (see FIG. 6).

Intermediate angles between the polarisation axes will give a transmittance that is almost linearly variable between minimum and maximum.

The component of the incident electromagnetic radiation that is not polarised by the metallic pattern is transmitted at percentages relative to the degree of transmittance, for the specific wavelengths, of the transparent materials used.

One or both of the polarisers is or are connected to one or more linear translatory movement systems of known types, for example electromechanical or precision hydraulic systems.

The translatory motion is regulated by electrical inputs sent to the actuators by a micro-controller connected to various sensors for monitoring environmental variations (internal and external luminosity at various VIS and/or NIR wavelengths, temperature, humidity, the presence of humans in the premises, predictive inputs deriving from the Internet or from static/dynamic simulation models communicating with the micro-controller) and the user's temporary or permanent choices (settings: seasonal, monthly, daily, hourly and according to environmental benchmarks).

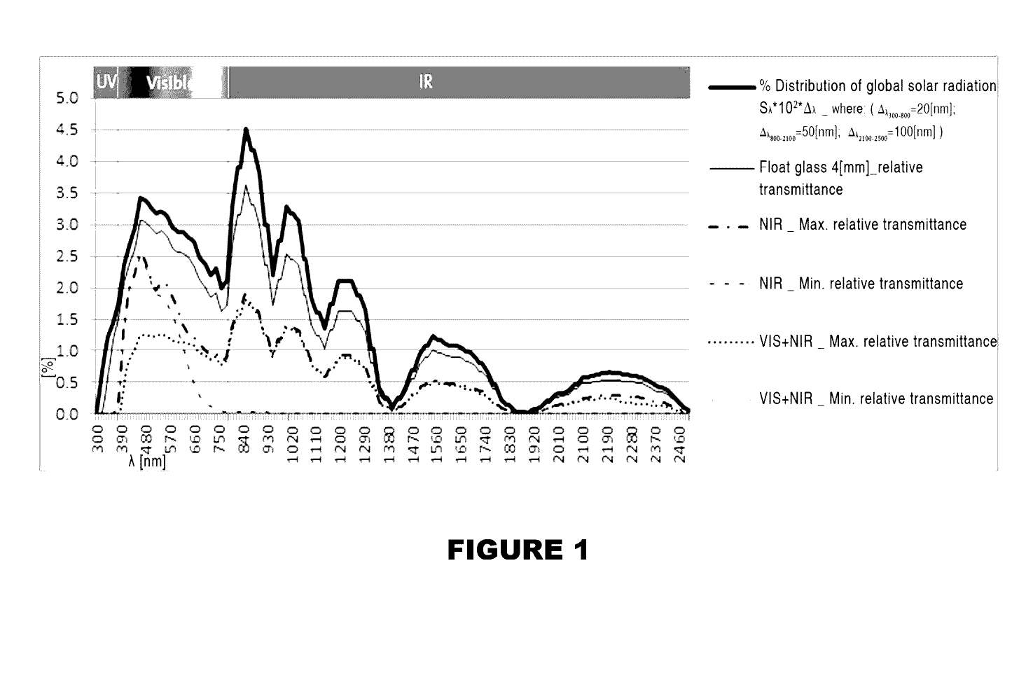

FIG. 1 shows the selective transmittance characteristics, by way of example, for VIS+NIR implementation (e.g. double filter, inter-wire pitch of approximately 100 [nm], wire height approximately 100 [nm]) and NIR implementation (e.g. double filter, inter-wire pitch of approximately 230 [nm], wire height approximately 120 [nm]). The values are placed in relation to the percentage energy distribution of the solar spectrum.

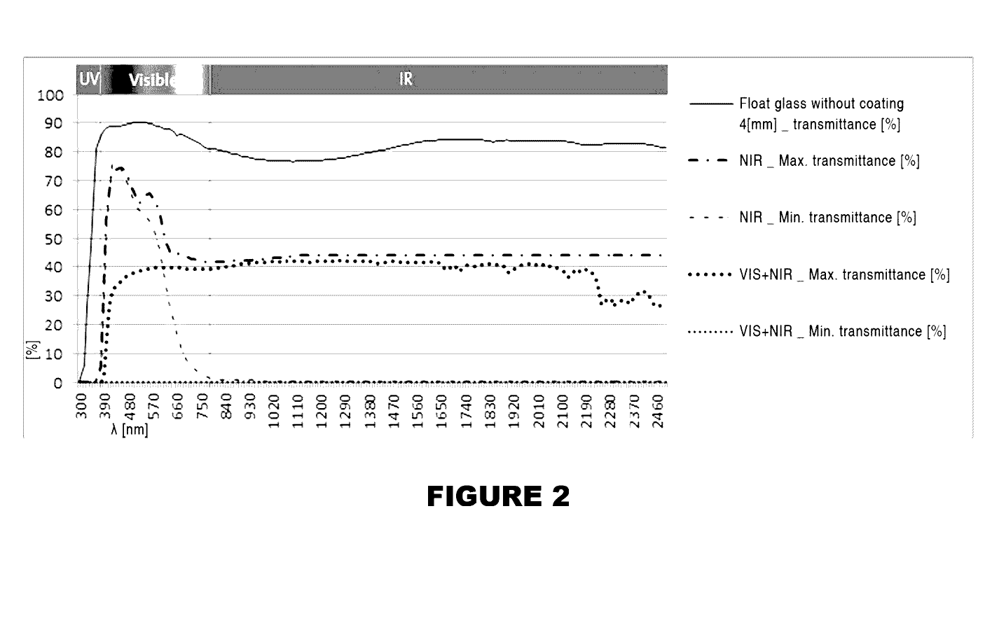

FIG. 2 shows, on a [%] scale, the spectral transmittance values of the same devices, exemplifying the implementation and performance possibilities of this invention.

With respect to traditional screening systems, the device according to the present invention allows a clear outward view at all times, does not require any maintenance and is therefore free from any additional costs; it does not need to be tested for stress from snow or wind, or to be subjected to checks on corrosion from acid attacks, saline/marine corrosion or oxidation, since it can be protected by positioning it in the glazed cavity, which is sealed, and the air inside it is replaced with insulating gases such as argon, krypton or xenon or with dehydrated air, and/or may be modified with molecular absorbers suitable for the purpose. The device can be regulated at will by means of intelligent control systems that take decisions based on the user's choices and changes in internal and external environmental conditions. It can be controlled remotely or via the Internet. It can restore from a database or instantaneously from the recorded values, and the control system can interact with dynamic simulation models for the buildings.

The control hardware and software may be Open and customisable by the user, who can choose which variables control it (internal illumination, position and presence of the sun, temporal, seasonal or hourly variables, internal and/or external temperature, manual choices), and is therefore adaptable to any orientation and different latitudes.

Since it is not necessary to open the transparent surface, there is an immediate reduction in thermal dispersion through ventilation and a maximisation of the air-sealing efficiency of modern window and door frames.

If the device according to the present invention is integrated into a glazed system, it is fitted and regulated directly with the window and therefore does not require any further fitting stages. It also increases the lifespan of any organic substrate and the acoustic insulation between the inside and outside (if installed with and/or in an external and/or internal laminated window).

With respect to internal screening, in addition to the advantages cited above, the device described herein substantially reduces the energy needs of the building for air-conditioning in summer, since almost all of the radiation not directly transmitted is reflected to the outside.

With respect to windows that use TIM (Transparent Insulation Material) as a filler for the frame, the device according to the present invention solves the problem of clarity, which in windows with TIM is negated by the translucence of the products used. It can also be coupled with TIM technologies where there is the possibility of installing a triple-glazed window in order to reduce heat exchange through conduction/convection (in climates with extremely harsh winters).

As a further advantage, the device according to the invention allows programmable dynamic control.

With respect to photochromic and thermochromic variable-transparency windows, the device according to the present invention allows a greater solar contribution in winter.

Photochromic windows are not suitable in building construction, since even in winter, they darken if hit by direct radiation, thus negating the free solar contributions to the premises, and do not allow the personalised regulation of transparency.

A further advantage of the invention is represented by the virtually instantaneous transition times, compared with the average 30 minutes for thermochromic units. It has a wide range of transmittance levels, compared with the two levels of thermochromic units (25-55% Cool and 5-12% Warm), and is capable of selectively and drastically reducing the infrared radiation, allowing visible radiation to pass through. In some cases, thermochromic windows reduce transparency in the visible range only, while in others they reduce the transmittance of visible and near-infrared in an almost linear fashion.

With respect to electrochromic variable-transparency windows, the present invention provides a longer lifespan, since it does not work through cycles of chemico-physical transformation but instead uses the vectorial nature of the light in its favour. Its main chemical composition and its state remain unaltered in all normal conditions of use; it does not consume any electrical energy in order to remain transparent; and it does not generate constant electromagnetic fields, which are potentially damaging to humans.

Many electrochromic devices have only a few (3-5) levels of transparency to choose from, unlike the device according to the present invention, which offers a much wider choice.

The device described herein can be designed as a stand-alone device that is self-sufficient, in terms of energy, for periods of between 3 and 6 months according to the orientation and usage settings. After this period, it can be recharged in a few hours like a normal portable device. Electrochromic devices, on the other hand, have an average discharge time of 60 minutes, since even the best consume an average of 0.3 [W/mq] at 12 [Volt] to maintain transparency and therefore require a continuous network power feed.

The present invention finds an industrial application in all applications where it is necessary or desirable to obtain a screening of electromagnetic radiation, particularly light radiation, and more particularly solar radiation. For example: civil and industrial architecture (vertical, horizontal or inclined closures, including those of small and medium-sized dimensions); internal finishings for the separation of rooms.

1. A transparent multilayer device, comprising two polarisers comprising a grid of nano-wire filaments, said polarisers being arranged in succession along a path of the direction of propagation of electromagnetic radiation and being capable of linear translatory movement relative to one another, wherein the pitch between the filaments is constant and less than 390 nm and the filaments occupy an essentially constant space between 2.5% and 50% of the pitch and are organized in parallel bands of regular shape, wherein the bands are of the same dimensions but have different orientations of a polarisation axis, and wherein the polarisation axis of each band is rotated with respect to adjacent bands, and through constant angles selected in the range between tenths of a degree and 45 degrees.

2. (canceled)

3. The device according to claim 1, in which the filaments are oriented along a transparent substrate, and optionally are covered by a transparent protective layer.

4. The device according to claim 1, in which each of the polarisers contains a multitude of polarisation axes according to the width and number of bands.

5. The device according to claim 1, in which the translatory movement is horizontal, vertical, curvilinear or sinusoidal, with sections of different or oblique orientations.

6. The device according to claim 1, in which the filaments of the polariser comprise a constant pitch between 160 nm and 390 nm.

7. The device according to claim 1, in which the filaments comprise a constant pitch of less than 160 nm.

8. (canceled)

9. The device according to claim 1, further comprising a depolarizer through which the electromagnetic radiation passes along its direction of propagation, before striking the polarisers.

10. (canceled)

11. The device according to claim 1, in which the polarisers contain a transparent substrate having a refractive index calculated to exclude high orders of diffraction.

12. The device according to claim 11, in which the substrate comprises an inorganic or organic material with a high capacity for transmittance of visible (VIS) or near-infrared (NIR) radiation, and optionally with a high capacity for absorption of ultraviolet (UV) radiation.

13. The device according to claim 1, in which the polarisers comprise a reticle having a high reflective index.

14. The device according to claim 1, in which the nano-wire filaments comprise a multistrate consisting of dielectric material alternating with layers of non-dielectric material.

15. The device according to claim 11, in which there is a layer of dielectric material between the substrate and the polarisers.

16. (canceled)

17. The device according to claim 1, in which the height of the nano-wire filaments is between 10 nm and 1 micron.

18. The device according to claim 1, in which the width of the bands is between 5 micrometres and 9.9 metres.

19. The device according to claim 3, in which the filaments are covered by a protective layer comprising a filter for ultraviolet (UV) radiation.

20. The device according to claim 1, in which the axes of the polarisers are parallel to each other and aligned along the direction of propagation of electromagnetic radiation.

21. The device according to claim 1, in which the axes of the polarisers are orthogonal to each other and aligned along the direction of propagation of electromagnetic radiation.

22. The device according to claim 1, in which the axes of the polarisers are arranged at intermediate angles.

23. (canceled)

24. A glazed system, comprising a glazed window and the device according to claim 1.

25. A system, comprising the device of claim 1 and a controller.
